(19) United States
(12) Patent Application Publication
(10) Pub. No.: US 2019/0346369 A1
(43) Pub. Date: Nov. 14, 2019

(54) MOBILE PHONE BASED FLUORESCENT MULTI-WELL PLATE READER

(71) Applicant: THE REGENTS OF THE UNIVERSITY OF CALIFORNIA, Oakland, CA (US)

(72) Inventors: Aydogan Ozcan, Los Angeles, CA (US); Omai Garner, Culver City, CA (US); Dino Di Carlo, Los Angeles, CA (US); Qingshan Wei, Los Angeles, CA (US); Derek Tseng, Buena Park, CA (US); Janay Kong, Los Angeles, CA (US)

(73) Assignee: THE REGENTS OF THE UNIVERSITY OF CALIFORNIA, Oakland, CA (US)

(21) Appl. No.: 16/477,193

(22) PCT Filed: Jan. 17, 2018
(86) PCT No.: PCT/US18/13981

§ 371 Date: Jul. 11, 2019

Related U.S. Application Data
(60) Provisional application No. 62/477,146, filed on Mar. 27, 2017.

(51) Int. Cl. G01N 21/64; G02B 6/08

(52) U.S. Cl. CPC G01N 21/6452; G01N 21/6428; G01N 21/648; G01N 2021/6439; G01N 2021/6484; G01N 2201/0221; G02B 6/08

(57) ABSTRACT

A multi-well plate reader device includes an opto-mechanical attachment configured to attach/detach to a portable electronic device having a camera. The reader includes a plurality of excitation illumination sources and a slot that receives a well plate. Excitation and emission filters are incorporated into the housing. Optical fibers are located in the attachment and transmit fluorescent light emitted from the wells of the well plate through an optional lens and into the camera. The optical fibers have an input end adjacent to the wells and an output end formed in a header, wherein, in one embodiment, multiple optical fibers are positioned within a cross-sectional area projection defined by the wells and wherein the output ends of optical fibers are mounted in the header. The pattern of the optical fibers is mapped to individual wells in a calibration operation and stored in a fiber map.

### RELATED APPLICATION

This application claims priority to U.S. Provisional Patent Application No. 62/447,146 filed on Jan. 17, 2017, which is hereby incorporated by reference in its entirety. Priority is claimed pursuant to 35 U.S.C. § 119 and any other applicable statute.

### STATEMENT REGARDING FEDERALLY SPONSORED RESEARCH AND DEVELOPMENT

This invention was made with Government support under Grant Number 1332275, awarded by the National Science Foundation. The Government has certain rights in the invention.

### TECHNICAL FIELD

The technical field generally relates to portable diagnostic testing devices. More specifically, the technical field relates to a microplate reading device for reading the fluorescent intensities of individual wells of a microplate that is used in conjunction with a portable electronic device such as a mobile phone.

### BACKGROUND

Point-of-care (POC) tests are increasingly being needed and utilized for clinical applications. Key challenges with POC tests include achieving a low cost, portable form factor, and stable readout, while also retaining the same robust standards of benchtop and lab-based tests. Fluorescence microplate reader devices are well known and assist life science and drug discovery researchers who require absorbance measurements of target molecules. These conventional microplate reader devices are, however, rather large and complex devices that are not suitable for POC testing. Typically, these microplate reader devices are larger benchtop systems that are quite large and require a separate computer system for data acquisition and reporting. As an example, the BioTek™ FLx800™ Fluorescence Reader device has dimensions of 15″×16″×9″ and weighs 10 lbs. Further, these conventional devices microplate reader devices require specialized training to operate them.

Mobile phone based, hand-held microplate readers for POC testing of enzyme-linked immunosorbent assays (ELISA) have been described. For example, Berg et al. describe a mobile phone based colorimetric microplate reader device that uses an opto-mechanical attachment to hold and illuminate a conventional 96-well plate using a light-emitting diode (LED) array. See Berg et al., Cellphone-Based Hand-Held Microplate Reader for Point-of-Care Testing of Enzyme-Linked Immunosorbent Assays, ACS Nano, Vol. 9, No. 8, pp. 7857-7866 (2015). In the Berg et al. device each well of the 96-well plate utilized a single optical fiber. Further, the opto-mechanical attachment used a header that required the ends of the array of optical fibers to be arranged in the same row, column format as the corresponding 96-well plate for imaging. This required a significant amount of labor and time to prepare the fibers in the correct configuration so that the reduced array of fibers matched the corresponding row and column configuration of the wells. In addition, the Berg et al. configuration, each well of the 96-well plate included a single fiber that was used to collect and transmit fluorescent light to the camera of the mobile phone.

### SUMMARY

In one embodiment, a multi-well plate reader for use with a portable electronic device having a camera therein includes an opto-mechanical attachment configured to attach/detach to the portable electronic device. The attachment includes a plurality of excitation illumination sources, an excitation filter (that filters light from the array of excitation illumination sources). A slot is disposed in the opto-mechanical attachment and dimensioned to receive an optically transparent plate containing an array of wells therein. An emission filter is provided adjacent to the underside of the slot to filter fluorescent light that is emitted from sample contained in the wells.

The opto-mechanical attachment includes plurality of optical fibers for transmitting fluorescent light that is emitted from the array of wells after first passing through the emission filter, wherein each optical fiber of the plurality of optical fibers terminates at a first end in a base plate contained in the opto-mechanical attachment and forming an input array of optical fibers, wherein multiple optical fibers are positioned within a cross-sectional projection area defined by each of the wells of the optically transparent plate. Thus, each well in the array has a plurality of separate optical fibers associated therewith (or in other embodiments a single fiber). The plurality of optical fibers terminate at a second end in a header to form an output array of optical fibers, wherein the output array of optical fibers in the header has a cross-sectional area that is smaller than a the area of the array of wells in the optically transparent plate and wherein the output array of optical fibers are mounted in the header. In one preferred embodiment, the optical fibers are randomly mounted in the header and include multiple fibers per well. An optional lens is disposed in the opto-mechanical attachment and interposed in an optical path formed between the array of optical fibers in the header and the camera of the portable electronic device.

In one embodiment, the opto-mechanical attachment or reader device includes calibration data that is associated with the opto-mechanical attachment. The calibration data may include a fiber map that maps each of the optical fibers in the header to a particular well of the array. In one embodiment, the calibration data may be stored in a bar or QR code that is disposed on the opto-mechanical attachment. Alternatively, the calibration data may be stored in a memory or chip that is located on or within the opto-mechanical attachment. The calibration data may also be stored separate from the opto-mechanical attachment. For example, the opto-mechanical attachment may link a particular unique code associated with the opto-mechanical attachment (e.g., serial number, bar code, QR code) that is then used to look-up or retrieve calibration data that is stored in a computer database or the like (e.g., look-up table) that is transferred or downloaded to the software or application running on a computing device or the portable electronic device.

In another embodiment, a method of using the multi-well plate reader fluorescent reader includes securing the opto-mechanical attachment to the portable electronic device and inserting the optically transparent plate containing samples pre-loaded therein into the slot of the opto-mechanical attachment. The optically transparent plate may also be inserted into the slot prior to securing the opto-mechanical attachment to the portable electronic device. The wells in the optically transparent plate are illuminated using the array of excitation illumination sources. At least some of the wells contain one or more fluorescent reporters (e.g., probes, dyes, fluorescent molecules or species) that emit fluorescent light in response to the excitation illumination. Light from the wells is then captured via a plurality of optical fibers associated with each well of the optically transparent plate. This captured fluorescent light the optical fibers is output via a bundle of optical fibers that are secured to a header. The optical fibers form a bundle and are arranged within the bundle in a random arrangement or, alternatively, in a non-random arrangement such as a pattern.

A pattern image of the fluorescent light emitted by the bundle of optical fibers is then acquired using the camera functionality of the portable electronic device. The pattern image is transferred to a remote computer or a local computing device. In other embodiments, there is no transfer of the image and the image is processed on the portable electronic device. The transmitted pattern image is then processed in the remote or local computing device (or, alternatively, the portable electronic device) to segment the image into individual areas of light corresponding to light emitted from individual optical fibers. The software uses a fiber map that identifies the location of each segmented region of the image to a particular well. In one preferred embodiment, there are multiple optical fibers associated with each well. Thus, for example, in one embodiment, each well is associated with three (3) different optical fibers. There could be as few as two (2) fibers or more than three (3) fibers. In an alternative embodiment, each well is associated with only a single fiber. The locations of each optical fiber within the bundle are known using the fiber map that identifies what fiber image (in the captured image) corresponds to what well. In one embodiment, the measured intensity of light among the plurality of optical fibers associated with each well is averaged. This averaged intensity that is obtained may be further normalized using a calibration curve or function that calibrates measured intensity to a known or “gold standard” sample. Using the software or the application, the normalized fluorescent intensity for the separate wells is used to generate a quantitative value corresponding to a concentration or a copy number (e.g., of nucleic acid) which can then be displayed on the portable electronic device. A qualitative result (e.g., positive or negative) may also be generated in some embodiments.

In one embodiment, a multi-well plate reader for use with a portable electronic device having a camera therein includes an opto-mechanical attachment configured to attach/detach to the portable electronic device. The reader includes an array of excitation illumination sources, an excitation filter, a slot disposed in the opto-mechanical attachment and dimensioned to receive an optically transparent plate containing an array of wells therein, an emission filter, and a plurality of optical fibers disposed in the opto-mechanical attachment and configured to transmit fluorescent light emitted from the array of wells and through the emission filter. Each optical fiber of the plurality of optical fibers terminates at a first end in a base plate contained in the opto-mechanical attachment and forming an input array of optical fibers, wherein multiple optical fibers are positioned within a cross-sectional area defined by each of the wells of the optically transparent plate, wherein the plurality of optical fibers terminate at a second end in a header to form an output array of optical fibers therein, wherein the output array of optical fibers in the header has a cross-sectional area that is smaller than an area of the array of wells in the optically transparent plate and wherein the output array of optical fibers are mounted in the header. In certain preferred embodiments, the optical fibers are mounted in a random configuration and then mapped to individual wells in a calibration operation. An optional lens disposed in the opto-mechanical attachment and interposed in an optical path formed between the array of optical fibers in the header and the camera of the portable electronic device.

In another embodiment, a method of using the multi-well plate reader described herein includes the operations of: securing the opto-mechanical attachment to the portable electronic device; loading samples into separate wells in the optically transparent plate; inserting the optically transparent plate into the slot of the opto-mechanical attachment; illuminating the wells in the optically transparent plate using the array of excitation illumination sources; acquiring a pattern image of the fluorescent light emitted by the output array of optical fibers; transmitting the pattern image to a remote computing device or a local computing device; processing the transmitted pattern image in the remote or local computing device to map each location in the pattern to a particular well using a fiber map; averaging, for each well, the measured fluorescent intensity values from the plurality of optical fibers; normalizing the averaged fluorescent intensity values with fluorescent intensity values from a separate reader device; and returning a quantitative value or qualitative result corresponding to the normalized fluorescent intensity for the separate wells to the portable electronic device for display thereon.

In another embodiment, a method of using the multi-well plate reader described herein includes the operations of: securing the opto-mechanical attachment to the portable electronic device; loading samples into separate wells in the optically transparent plate; inserting the optically transparent plate into the slot of the opto-mechanical attachment; illuminating the wells in the optically transparent plate using the array of excitation illumination sources; acquiring a pattern image of the fluorescent light emitted by the output array of optical fibers; processing the pattern image in the portable electronic device to map each location in the pattern to a particular well using a fiber map; averaging, for each well, the measured fluorescent intensity values from the plurality of optical fibers; normalizing the averaged fluorescent intensity values with fluorescent intensity values from a separate reader device; and displaying on the portable electronic device a quantitative value or qualitative result corresponding to the normalized fluorescent intensity for the separate wells.

### BRIEF DESCRIPTION OF THE DRAWINGS

FIG. 1A illustrates a perspective view of the multi-well plate reader for use with a portable electronic device (e.g., mobile phone).

FIG. 1B illustrates another perspective view of the multi-well plate reader of FIG. 1A.

FIG. 1C illustrates a perspective and partial cut-away view of the multi-well plate reader of FIG. 1A.

FIG. 1D illustrates a cross-sectional view of the multi-well plate reader of FIG. 1A.

FIG. 2A illustrates a front view of a mobile phone according to one embodiment.

FIG. 2B illustrates a back view of the mobile phone of FIG. 2A.

FIG. 3 schematically illustrates the transfer of images, data, and results between the multi-well plate reader and a computing device according to one embodiment.

FIG. 4A illustrates a representative image of obtained using the multi-well plate reader device. Illustrated is the captured output pattern from the output side of the randomly arranged optical fibers. Illuminated fibers are associated with well #s 1, 5, 13, 17, 19, 21, and 25 are illustrated.

FIG. 4B illustrates the wells of the optically transparent plate that were used to generate the captured output pattern of FIG. 4A. Dark wells are those that emit fluorescent light.

FIG. 5 illustrates the sequence of operations that are performed to create normalized well intensity values using the multi-well plate reader according to one embodiment.

FIG. 6 illustrates calibration functions for all 25 wells with well #1 highlighted (dark curve in bold) along with original data points circled.

FIG. 7 illustrates a comparison of fluorescence readings between the conventional benchtop plate reader and the mobile phone reader device for fluorescein solutions.

FIG. 8A illustrates mobile phone intensity readings as a function of fluorescein concentration (e.g., titration curve) for the well #1 position.

FIG. 8B illustrates an enlarged view of rectangular region of FIG. 8A. The graph shows good linear regression and threshold (solid horizontal line) based on 3 times standard deviation (StDv) of the blank to determine the LODs.

FIG. 9A illustrates endpoint/initial fluorescence fold changes for 30, 40, 50, and 60 minute assays when imaged with the benchtop plate reader. Threshold values for each endpoint are shown as horizontal lines and are defined as the mean 0 DNA fluorescence value plus 3 standard deviations. Error bars indicate StDv.

FIG. 9B illustrates endpoint/initial fluorescence fold changes for 30, 40, 50, and 60 minute assays when imaged with the mobile phone reader. Threshold values for each endpoint are shown as horizontal lines and are defined as the mean 0 DNA fluorescence value plus 3 standard deviations. Error bars indicate s.d.

FIG. 10 illustrates the limit of detection (LOD) of λ DNA when using the LAMP assay and measuring fluorescence with the mobile phone reader following amplification for increasing amounts of time up to 60 minutes. Characteristic fiber images of each of the λ DNA concentrations are shown below each of the corresponding endpoints with the LOD highlighted with a square outline.

### DETAILED DESCRIPTION OF THE ILLUSTRATED EMBODIMENTS

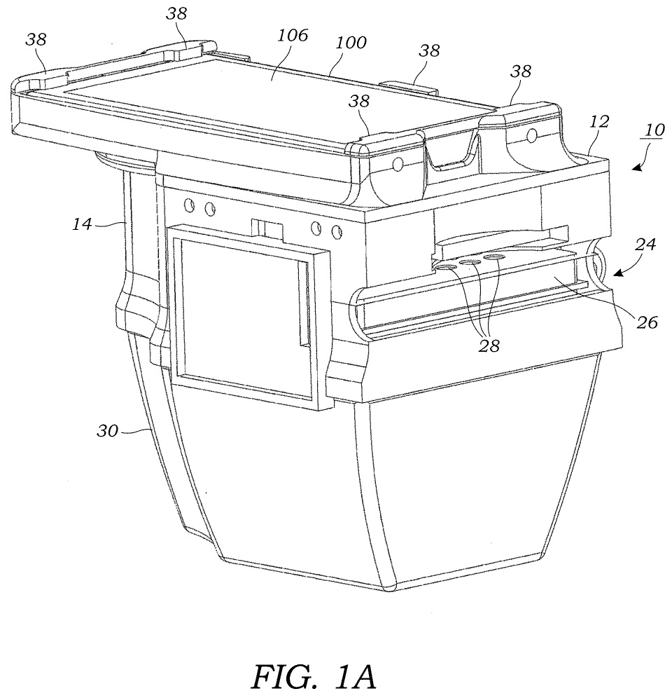

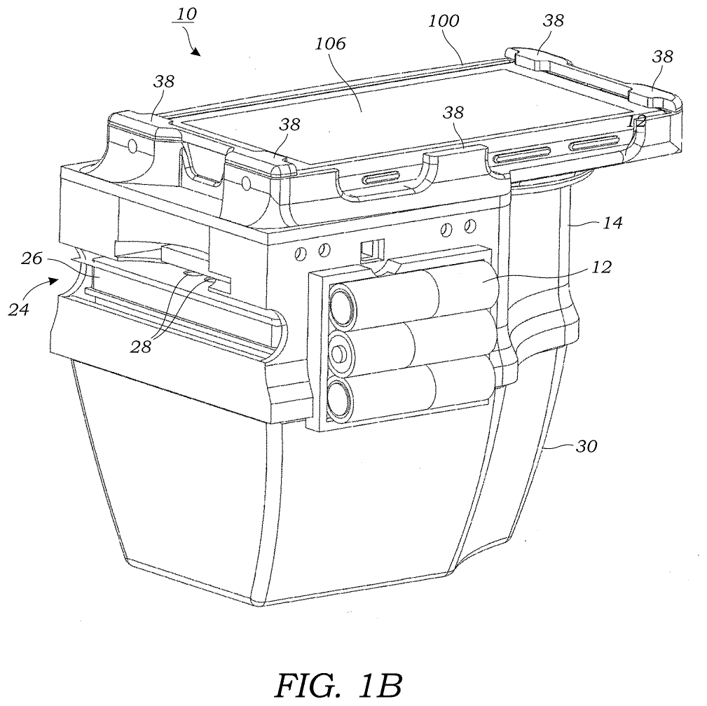

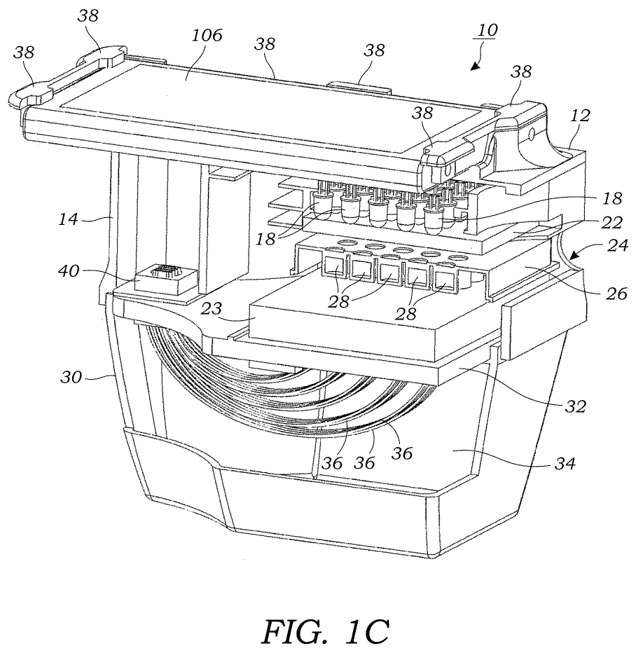

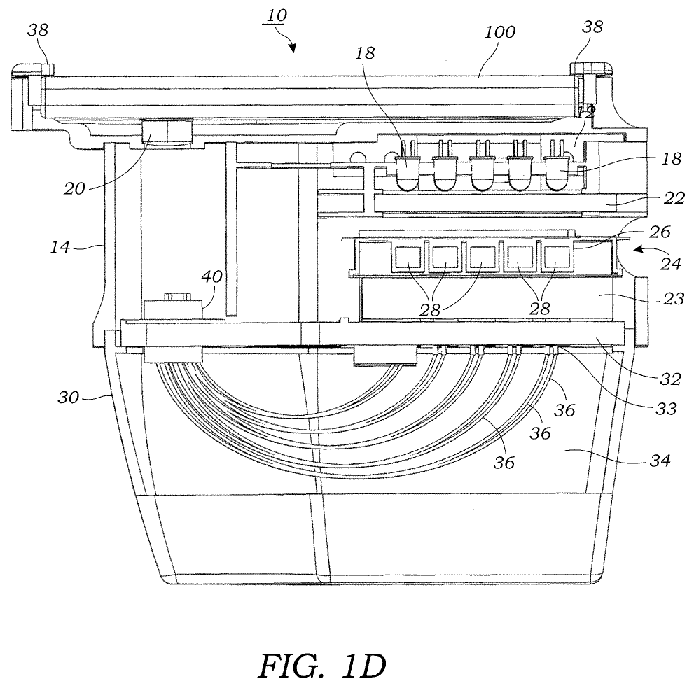

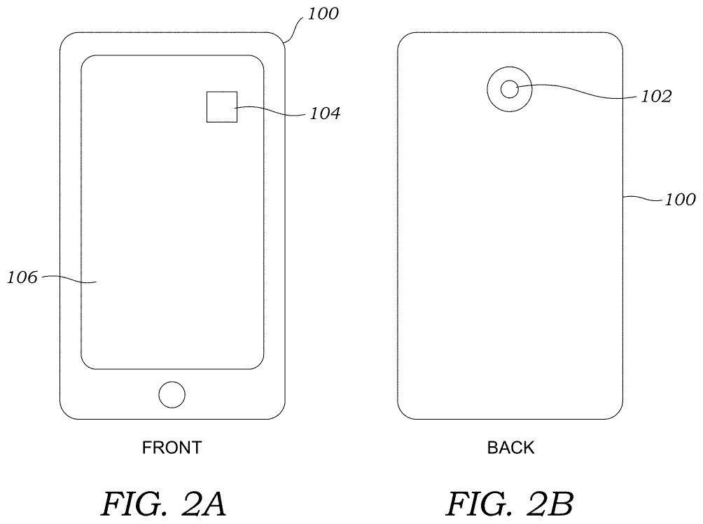

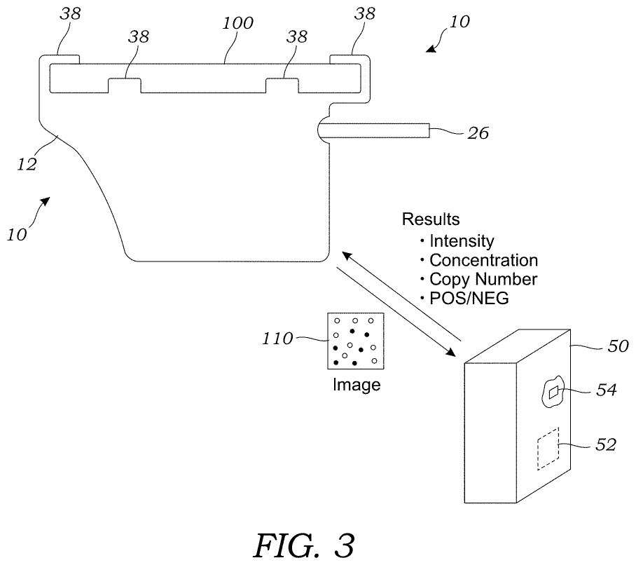

FIGS. 1A, 1B, and 1C illustrate an embodiment of a multi-well plate reader 10 for use with a portable electronic device 100 having a camera 102 as illustrated in FIGS. 2A and 2B. In this example, the portable electronic device 100 is a mobile phone or cell phone (e.g., Smartphone) although the portable electronic device 100 may also include other portable electronic devices with a camera 102. These include, for example, tablet PCs, webcams, and digital cameras. The portable electronic device 100, in another embodiment, may be a stand-alone imager that is specially made to be used with the multi-well plate reader 10. The multi-well plate reader 10 is, in one particular embodiment, portable and is hand-held (either with one or both hands depending on portable electronic device 100 being used). In one embodiment of the invention, the portable electronic device 100 also has wireless functionality such that images, data, and results may be transferred to a local computer, remote computer or server as explained herein. Wireless functionality may occur over a Wi-Fi network that is connected to the Internet or other local or wide area network. Alternatively, wireless functionality may be provided on a mobile phone network. Bluetooth® wireless transfer may also be used to transfer data and images to a physically nearby yet separate remote computer. As an alternative to wireless image and data transfer, one or more wired connections may connect the portable electronic device 100 with a computing device 50 such as a local or remote computer (seen in FIG. 3).

In one embodiment of the invention, the portable electronic device 100 includes software or an application 104 as illustrated in FIG. 2A that runs or is executed on the portable electronic device 100. A user may interface with the application 104 using a graphical user interface (GUI) that is displayed on the display 106 of the portable electronic device 100. The application 104 may be used by the user to run the test, transfer data and image files to a local/remote computer (optional), receive data from the local/remote computer (optional), process images obtained on the portable electronic device 100, and output qualitative and/or quantitative results to the user. Thus, in one embodiment, images that are obtained using the portable electronic device 100 are transferred to a remote or local computer 50 as illustrated in FIG. 3 for image processing and data analysis.

In still other embodiments as described herein, image processing and data analysis may occur exclusively on the portable electronic device 100 in which case there is no need to transfer/receive data and images to a separate local or remote computer. Of course, this option may require additional computation resources that might not be available on all portable electronic devices 100. As seen in FIGS. 1A, 1B, 1C, the multi-well plate reader 10 includes an opto-mechanical attachment 12 that is configured to attach/detach to the portable electronic device 100. As best seen in the cross-sectional view in FIG. 1C, the opto-mechanical attachment 12 may be formed from multiple parts that house various components of the multi-well plate reader 10. As seen in FIG. 1C, the opto-mechanical attachment 12 includes an upper housing portion 14, which is secured to the portable electronic device 100 and contains the power source 42 (FIG. 1B), illumination sources 18 (FIGS. 1C and 1D), optional lens 20 (FIG. 1D), excitation filter 22 (FIGS. 1C and 1D), emission filter 23 (FIGS. 1C and 1D), and defines a slot or recess 24 that is used to receive an optically transparent multi-well plate 26. The optically transparent multi-well plate 26 contains a plurality of wells 28 formed therein; typically in an arrayed fashion in rows and columns. The opto-mechanical attachment 12 includes a lower housing portion 30 that holds a base plate 32 (FIGS. 1C and 1D) and is secured to the upper housing portion 14 and includes a free space volume 34 (FIGS. 1C and 1D) that provides space for the optical fibers 36 described herein.

As seen in FIGS. 1A-1C, the upper housing portion 14 of the opto-mechanical 12 attachment may include one or more fasteners 38 such as tabs, clips, or the like that are used to removably fasten the opto-mechanical attachment 12 to the portable electronic device 100. As seen in FIGS. 1A-1C, the opto-mechanical attachment 12 is secured to the “back” side of the portable electronic device 100 (e.g., the back of the mobile phone that has the camera 102 located on the back as seen in FIG. 2B) leaving the display 106 unobstructed so that it can be used while the opto-mechanical attachment 12 is secured thereto. The opto-mechanical attachment 12 may be made from a number of different materials although polymer-based (e.g., plastic) materials provide for a sturdy yet lightweight construction. The opto-mechanical attachment 12 may be designed specifically to fit a particular brand or model of portable electronic device 100. Alternatively, the opto-mechanical attachment 12 may include one or more adjustable fasteners 38 or the like such that a single version of the opto-mechanical attachment 12 may be used on different makes and models of portable electronic devices 100 which have different sizes and different locations of the camera 102. The opto-mechanical attachment 12 defines a housing that contains the various components required for the illumination of the micro-plate as well as the optical components required to transmit collected light to the camera of the portable electronic device 100.

The multi-well plate reader 10 includes a plurality of illumination sources 18 (FIGS. 1C and 1D) that are used to illuminate the wells 28 of the optically transparent plate 26 as explained herein. In one preferred embodiment, the plurality of illumination sources 18 are configured as an array of illumination sources. For example, for the experiments described herein, the plurality of illumination sources 18 is an array of twenty-five (25) blue light emitting diodes (LEDs). Alternatively, laser diodes may be used as the illumination sources 18. While blue colored light was emitted it should be appreciated that other colors could be used. The multi-well plate reader 10 includes a slot or recess 24 that is dimensioned to accommodate the optically transparent plate 26 that contains an array of wells 28 contained therein. The slot or recess 24 may be partially exposed at the opening as illustrated in FIGS. 1A-1D. Alternatively, the slot or recess 24 may be closed using an optional hinged door (now shown) that is opened to insert or remove the optically transparent plate 26 and closed when imaging is performed. The multi-well plate reader 10 includes an excitation filter 22 that is interposed between the plurality of illumination sources 18 and the optically transparent plate 26. An emission filter 23 is interposed between the lower portion of the optically transparent plate 26 and the receiving or “input” ends of the optical fibers 36 described herein.

The optically transparent plate 26 contains an array of wells 28 that are typically arranged in rows and columns. In the experiments conducted herein, a 5×5 array having twenty-five (25) total wells 28 was used but it should be understood that arrays having fewer wells 28 or more wells 28 may be used. For example, a common configuration is the so-called ninety-six (96) well plate which contains an 8×12 array of wells 28. Commercially available ninety-six (96) well plates are readily available and, in some embodiments, may be used with the multi-well plate reader 10 described herein. The slot or recess 24 is dimensioned to have a depth and width to accommodate the optically transparent plate 26. The slot or recess 24 preferably is dimensioned so that, when fully inserted into the opto-mechanical reader 10, each well 28 is positioned adjacent to a plurality of separate optical fibers 36 (FIGS. 1C and 1D) as explained below. That is to say, in one embodiment, each well 28 has associated with it at least two optical fibers 36 that are located within a cross-sectional projection of the area of the well 28, although in other embodiments each well 28 may be associated with three, four, five, six, or more optical fibers 36. Each well 28 is sized to hold a sample therein. Typical volumes for wells 28 are smaller than 1 mL (e.g., ˜0.3 mL) to several mL. In an alternative embodiment, each well 28 may be associated with only a single optical fiber 36.

As seen in FIGS. 1A-1D, the opto-mechanical attachment 12 includes a plurality of optical fibers 36. The optical fibers 36 in one preferred embodiment are made from glass, multi-mode optical fibers 36 (e.g., 400 μm core diameter glass fibers such as FT400UMT optical fibers available from Thorlabs, Inc.). While polymer based optical fibers 36 may be used these types of fibers may tend to auto-fluoresce. Each optical fiber 36 of the plurality includes two ends. A first end of each optical fiber 36 is secured in position such that when the optically transparent plate 26 is inserted into the slot or recess 24 of the multi-well plate reader 10, the first end is located at or adjacent to one of the wells 28 located in the optically transparent plate 26. In one aspect of the invention, the opto-mechanical attachment 12 includes a base plate 32 that is used to secure the first ends of the optical fibers 36. The base plate 32 has a plurality of apertures 33 formed therein that receive the first ends of the optical fibers 36. The optical fibers 36 are secured in the apertures 33 using an adhesive or friction-fit and collectively define an input array of optical fibers 36. The optical fibers 36 can be secured to the base plate 32 using glue, adhesive, or other bonding material (or through friction or mechanical fit).

In one embodiment described herein, there is a single aperture 33 associated with each well 28 that is dimensioned to accommodate multiple optical fibers 36. In this regard, multiple optical fibers 36 are used to transmit light from a single well 28. The multiple optical fibers 36 are secured to the aperture 33 as a bundle or grouping of multiple optical fibers 26. This bundle or grouping of optical fibers 36 is generally located around the center of each well 28. In an alternative embodiment, there are multiple apertures 33 formed in the base plate 32 inside the diameter or perimeter of a single well 28 (each optical fiber 36 has its own distinct aperture 33). Of course, this later embodiment is more complicated to manufacture. The location of the apertures 33 in the base plate 32 is arranged to correspond to the location of the wells 28 in the optically transparent plate 26. For example, in an embodiment in which there are three fibers for each well 28 that are designed for a ninety-six (96) well 28 optically transparent plate 26, there are ninety-six (96) apertures 33 in which each aperture 33 contains a bundle or grouping of three (or a different number of) fibers 36 with each aperture 33 positioned within the diameter or perimeter of the well 28 when the optically transparent plate 26 is placed in the slot or recess 24. Alternatively, for a 96-well plate there may be 96*3 or 288 apertures 33 that are formed in the base plate 32 for receiving the first ends of the optical fibers 36. The base plate 32 defines a bottom surface of the slot or recess 24 and when the optically transparent plate 26 is placed on top of the base plate 32 when loaded into the opto-mechanical attachment 12.

The second or opposing end of the optical fibers 36 are secured to a header 40 (FIGS. 1C and 1D) formed in the base plate 32 to form an output array of optical fibers 36 therein. The optical fibers 36 thus bend from the input side at the base plate 32 and into the free space volume 34 where they are secured at their respective opposing ends to the header 40. The header 40 is used dramatically increase the density of optical signals generated from the wells 28. In particular, the output array of optical fibers 36 in the header 40 has a cross-sectional area A₂ (e.g., the area defined by the bundle of optical fibers 36), in one embodiment, that is at least ten times (i.e., <10×) less than the cross-sectional area A₁ of the input array of optical fibers 36 that are formed in the base plate 32 (the cross-sectional area A₁ may also be referred to as the cross-sectional area spanned by the columns and rows of wells of the optically transparent plate). Another way of saying this is that the density of “virtual” wells that is created at the header 40 by the array of optical fibers 36 is at least ten times as large as the density of actual wells 38 in the optically transparent plate 26.

With reference to FIG. 1D, the opto-mechanical attachment 12 includes an optional lens 20 therein. The location of the lens 20 is such that the lens 20 is interposed in an optical path formed between the array of optical fibers in the header 40 and the camera 102 of the portable electronic device 100. The lens 20 is secured in position in the upper housing portion 14 of the opto-mechanical attachment 12. Thus, the light that exits the array of optical fibers 36 in the header 40 passes through the lens 20 prior to reaching the camera 102 of the portable electronic device 100. In some alternative embodiments, the lens 20 may be omitted entirely. For example, depending on the size of the attachment and the focal length of the camera 102, there may be no need for a lens 20 as the lens in the portable electronic device 100 may be sufficient to focus the light spots from the output side of the optical fibers 36 in the header 40.

As best seen in FIG. 1B, a power source 42 is disposed on or in the opto-mechanical attachment 12. The power source 42 may include a number of batteries such as AAA batteries or the like as is shown. The power source 42 can be switched on or off using a conventional switch or the like or even a software based switch using the application 104 (not shown). A current regulator (not shown) may be included in the power circuit for the LEDs making up the illumination sources 18. Alternatively, the portable electronic device 100 may provide power to the opto-mechanical attachment 12 through a cable or other connection. To maximize uniform illumination of the optically transparent plate 26 containing the wells 28, the individual light sources 18 may be centered against multiple (e.g., four (4)) wells 28, although other orientations may be used as well. Illumination from the light sources 18 may optionally be further homogenized using one or more optional diffusion layers (not shown), although in a preferred embodiment the diffusion layers are omitted entirely to avoid auto-fluorescence. The one or more diffusion layers may include plastic diffuser sheets that have areas that cover substantially all of the optically transparent plate 26. In some embodiments, the diffusion layer(s) may be omitted entirely because the diffusion layer material may auto-fluoresce which will introduce unwanted light and noise into the optical system.

FIG. 3 illustrates how, according to one embodiment, the multi-well plate reader 10 transmits one or more images 110 to a computing device 50 that is used to analyze and process the one or more images 110. The computing device 50 includes image analysis software 52 that is executed using one or more processors 54. As explained herein, the computing device 50 may be a local computing device 50 that is co-located with the multi-well plate reader 10. Alternatively, the computing device 50 may be a remote computing device 50 that is located in a different location from the multi-well plate reader. For example, the computing device 50 may include a server or other computer that is connected to a wide area network such as the Internet whereby images 110 are transferred from the portable electronic device 100 to the computing device 50. Data and results that are generated using the image analysis software 52 can be returned to the portable electronic device 100 via the same network. The results or data that may be transmitted to the portable electronic device 100 may include intensity values or other measurements for each well 28. The results may also include, for example the concentration, of a species or target contained in each well 28 (e.g., biomarker). In some other embodiments, for example, that use nucleic acids, the results may indicate a copy number of target nucleic acids in a sample. Results may also include a qualitative result such as a “positive” or “negative” finding for a particular sample (which may be in a single or multiple wells 28) or a particular well 28. The target may include a target molecule or molecules. The target may include a target species such as cells, bacteria, viruses, pathogens, or the like.

As explained herein, in some embodiments, calibration data may be stored in the computing device 50 for the multi-plate reader 10. In other embodiments, the calibration data may be stored in the portable electronic device 100. The calibration data may be stored in a memory, storage device, computer-accessible database, or the like. The calibration data may also be stored or contained in the image analysis software 52. The calibration data, in one embodiment, calibrates the measured intensity (or averaged intensity) obtained from the multi-plate reader 10 to intensity levels obtained from a conventional benchtop or other reader device. The calibration data may include normalization factors that are divided (or multiplied) into the measured intensity values obtained using the multi-plate reader 10 to create normalized intensity levels for the wells 28 read using the multi-plate reader 10. The calibration data may also include a fiber map or equivalent (e.g., fiber mapping data) that maps or associates each optical fiber in the header 40 to a particular well 28. For example, the fiber map may contain the specific or relative location (relative to other fibers or landmarks in the image 110) of the optical fibers 36 in the header 40 which is captured in the image 110. The fiber map or fiber data may be contained in a memory, bar code, QR code that is associated with the multi-well plate reader 10. The fiber map or fiber data may also be looked up using the unique serial number of the multi-well plate reader 10.

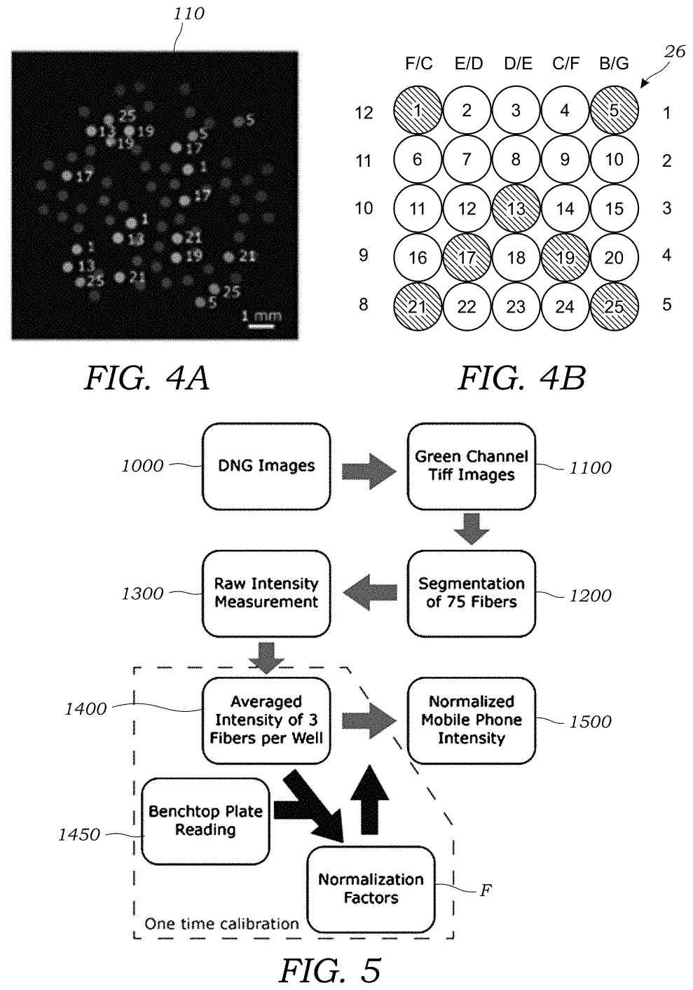

FIG. 4A illustrates how, in one embodiment, the optical fibers 36 are secured to the header 40 in a single bundle with the individual optical fibers 36 being arranged in a random pattern. In particular, FIG. 4A illustrates the output image optical fibers 36 from seven (7) wells 28 that emit fluorescent light. In this particular example, each well 28 is associated with three (3) separate optical fibers 36. The ends of these three optical fibers 36 are arranged randomly within a bundle of all the optical fibers 36 that is secured to the header 40. In one embodiment, a hole or aperture is formed in the header 40 that approximates the overall cross-sectional diameter of the bundle of optical fibers 36. The optical fibers 36 are bundled together in a random fashion and inserted into the aperture of the header 40 and secured in place with a liquid epoxy. Note that this avoids the laborious and time-intensive process of inserting optical fibers 36 into the header in the same row/column manner as found in the array of wells 36. The ends of the optical fibers 36 within the bundle are then cut and polished.

While FIG. 4A illustrates a preferred embodiment in which multiple optical fibers 36 are associated with a single well 28 and the output ends are secured in the header 40 in a bundle with the optical fibers 36 arranged in a random pattern, it should be appreciated that in alternative embodiments, a single optical fiber 36 may be associated with a single well 28. The output ends of the optical fibers 36 from all the wells may be arranged in a random arrangement or non-random arrangement such as in a pattern (e.g., a regular array with rows or columns or the like). In this alternative arrangement with a single optical fiber 36 for each well 28 there is no need for the averaging operation because each well 28 only has a single optical fiber 36.

As noted herein, one advantageous feature of this embodiment is that there is no need to arrange the optical fibers 36 in an array or regular format in the header 40 that matches the array format of the “input” side of the optical fibers 36. The optical fibers 36 can be arranged in a random arrangement within a bundle and each optical fiber 36 can then be mapped to a particular well 28 in a calibration process where a single well 28 is illuminated and the locations of the optical fibers 36 in the image 110 are found and identified to create a visual map of the location of each optical fiber 36 and its respective well 28 within the image. As seen in FIG. 4A, an image 110 is shown of a 5×5 optically transparent plate 26 that was obtained with the portable electronic device 100 where wells numbers 1, 5, 13, 17, 19, 21, and 25 emitted light. Thus, each of these wells had three corresponding optical fibers 36 that produced respective bright spots in image 110. The optical fibers 36 for each of these wells 28 are labelled with their respective well number in FIG. 4A. For example, there are three (3) optical fibers with the “1” designation which correspond to the three optical fibers 36 that transmit light from well #1. Corresponding well positions in the optically transparent plate 26 are shown in FIG. 4B.

FIG. 5 illustrates the sequence of operations that are performed to create normalized well intensity values using the multi-well plate reader 10 according to one embodiment. In FIG. 5, the multi-well plate reader 10 has been loaded with the optically transparent plate 26 and the portable electronic device 100 has been secured to the opto-mechanical attachment 12. The plurality of illumination sources 18 is turned on and the software or application 104 is run to acquire images of the wells 28 of the optically transparent plate 26. As seen in operation 1000, the portable electronic device 100 acquires Digital Negative (DNG) images which are then converted to TIFF format single channel images in operation 1100 (other image formats may be used as well). In this particular example, the TIFF images are created into green channel images for the fluorescein fluorophore but it should be appreciated that other color channels may be used. This conversion of images may take place on the portable electronic device 100 or on the local or remote computing device 50 where the images 110 (e.g., image files) are transferred to. The output images 110 obtained from output of the optical fibers 36 are segmented into individual optical fibers as seen in operation 1200 (e.g., seventy-five (75) optical fibers for a 5×5 array with three (3) optical fibers 36 per well 28). This segmentation process may take place using the image analysis software 52.

As seen in operation 1300 of FIG. 5, raw intensity measurements are made for each optical fiber 36. Next, as seen in operation 1400 of FIG. 5, the intensity measurements for the three (3) optical fibers 36 that receive light from a single well 28 are then averaged. The averaged intensity for each well 28 is then normalized to produce a normalized intensity value using normalizations factors obtained using a benchtop plate reading device (or other “gold standard” device). With reference to FIG. 5, plate readings from a gold standard device such as a benchtop plate reading device 1450 are used to create normalization factors (F). For example, a normalization factor (F) can be obtained for each well 28 and at each assay concentration by using the following equation, wherein I represents measured intensity:

$$F = \frac{{I}_{portable electronic device}}{{I}_{plate reader}} \qquad Eq . 1$$

The normalization factor for each well 28 can then be divided into the averaged intensities obtained in operation 1400 to generate the final normalized intensity values for the reader device as seen in operation 1500. The normalized intensity values can then be used to generate a result that can then be displayed on the portable electronic device 100. The results may also include, for example the concentration, of a species or target contained in each well 28. For example, the intensity of the well(s) 28 may be used to correlate the concentration of a species or target contained in each well. In some other embodiments, for example, that use nucleic acids, the results may indicate a copy number of target nucleic acids in a sample. For example, counting the number of “positive” wells 28 may be used to determine the concentration of the initial sample using the Poisson distribution of molecules or targets. Results may also include a qualitative result or finding such as a “positive” or “negative” finding for a particular sample which may be in a single or multiple wells 28. It should be appreciated that the total fluorescent intensity or each well 28 may be monitored as a function of time or at a certain time period (e.g., at time zero or after an elapsed time period). This data may be displayed on the display 106 of the portable electronic device 100.

Experimental

Mobile Phone-Based Multi-Well Plate Fluorescence Reader

A mobile phone-based fluorescence plate reader was used for concentration measurements for fluorescein and enhanced loop-mediated isothermal amplification (LAMP) reactions that included hydroxynaphthol blue (HNB) an intercalating dye. The mobile phone-based multi-well plate reader includes a custom-designed 3D printed opto-mechanical attachment that is integrated with the camera module of a mobile phone (i.e., Smartphone (Nokia Lumia 1020)). In the 3D printed optical interface, an array of 5×5 blue LEDs (470 nm, DigiKey) was mounted above the optically transparent plate having wells formed therein and used as the excitation light source for fluorescence. Excitation (465/30 nm, OD 6, 50×50 mm, Semrock) and emission (530/30 nm, OD 6, 50×50 mm, Omega Optical) filters were placed above (excitation) and below (emission) the optically transparent plate, respectively, and fluorescence signal was collected from the transparent floor of each well by three individual multimode optical fibers (dia. 400 μm core, FT400UMT, Thorlabs) that are all placed in a base plate located at a plane that is parallel to the well plate. A total of 75 fibers (3 fiber-optic cables per well, and 25 wells in total) were bent within the attachment, forming a circular common end with each fiber randomly bundled together. This circular common end was mounted in the header that holds the ends of the fibers. This fiber common end, composed of 75 individual fibers, was then imaged by the Smartphone camera via a single lens (f=15 mm, Edmund Optics) located in the opto-mechanical interface that forms an imaging system together with the existing lens of the Smartphone with a demagnification factor of ˜2.2. Of course, larger numbers of fibers can be used for larger numbers of wells. Only twenty-five (25) wells (i.e., 5×5 array) were tested using this particular embodiment but larger numbers of fibers could be employed. For 96 wells, there would be (3*96) 288 such fibers. Of course, the larger sized array of wells could require additional optics which could increase the size of the device. Using twenty-five (25) wells which can be tested in two different loading orientations produces a test plate with fifty (50) wells for testing.

Excluding the mobile phone, the entire fluorescent reader platform weighs <600 g and its cost is estimated to be <100 USD not including the custom-fabricated large area optical filters, the cost of which can be reduced under large scale manufacturing. In a typical mobile phone based image acquisition experiment, an exposure time of 4 seconds was used with an ISO of 100. The focus was set to infinity and images were saved in the raw DNG (digital negative) format. To minimize the auto-fluorescence background, black 96 well plates with clear bottoms (Corning) were used for all measurements. While a mobile phone having a camera is disclosed herein, it should be understood that other portable electronic devices may also be used in connection with the opto-mechanical attachment. This includes tablet computers or PCs, webcams, or digital cameras.

As explained herein with regard to FIG. 5, the mobile phone acquires DNG images and mobile images converted to TIFF format single channel images (green channel for fluorescein). This conversion of images may take place on the mobile phone or on a remote computer where the image files are transferred to. For example, the mobile phone images may be transmitted to a server (remote computer) or a local computer using a wireless transfer protocol (e.g., Wi-Fi or Bluetooth®) or a cable. The output images obtained from output of the optical fibers are segmented into individual fibers (e.g., 75 fibers in this experiment). Raw intensity measurements are made for each fiber. The intensity measurements for the three fibers that receive light from a single well are averaged. The averaged intensity is then normalized to produce a normalized mobile phone intensity value using normalizations factors obtained using a benchtop plate reading device (or other gold standard device). This intensity or some other measure like concentration or copy number (e.g., of DNA) may then be returned to the mobile phone. For example, the intensity may be used to find the concentration of a target molecule or biomarker. Alternatively, the images may be processed using an application or software program loaded onto the mobile phone device itself. This would not require offloading of images or data to a remote server or local computer.

Characterization of the Limit of Detection (LOD)

To characterize the fluorescence limit of detection of the mobile phone based reader, fluorescein solutions (0-50 nM) were loaded into the wells of the optically transparent plate and imaged. The captured mobile images were first batch-converted to TIFF format single channel images (green channel for fluorescein) using ImageJ. A Matlab algorithm was used to automatically locate individual optical fibers in the output fluorescent light pattern image and their respective intensities were measured. A mapping function or table maps particular regions of the image pattern to a particular well. For each well, the intensities from three corresponding fibers were averaged and used as the intensity of that specific well. These average well intensities were then plotted against the concentration of fluorescein for each individual well, and linear fitting was performed within a concentration range of 0-10 nM. To better estimate the measurement errors, each plate for a given dye concentration was inserted, imaged, and removed for three independent cycles. The fluorescence LOD for each well was individually determined by the average signal of blank control (0 nM concentration) plus 3-times of its standard deviation (StDv). At the end of this process, the LOD was characterized for each well, and in total 25 LODs were obtained.

Intensity Normalization of Wells

A computational framework was developed to minimize small intensity variations from well-to-well due to the spatial variations of light intensity of LEDs as well as bending induced light transmission differences among individual optical fibers. In order to develop a normalization map, fluorescent well plates with varying intensity levels were imaged by both the mobile phone based multi-well reader device and a conventional benchtop plate reader, used as the gold standard in the measurements. Then, a normalization factor (F) was obtained for each well and at each assay concentration by using the following equation:

$$F = \frac{{I}_{cellphone}}{{I}_{plate reader}} \qquad Eq . 2$$

where I_{cellphone} represents the raw intensity of the mobile phone based readout, and I_{plate reader} represents the corresponding gold standard reading from a benchtop plate reader. Nonlinear curve fitting was then performed to the scattered plot of mobile phone raw intensity (I_{cellphone}) versus normalization factor (F) to form a normalization function for each well. Finally, normalized mobile phone intensities were obtained by dividing (or multiplying) the mobile phone raw intensities by the corresponding normalization factors determined by the fitting functions. This normalization procedure need only be performed only once to determine the normalization function for each well and can remain the same for the rest of the experiments.

Results and Discussion

The mobile phone based fluorescent plate reader device is assembled via exchangeable 3D-printed parts. The compactness of this fluorescence reader platform that images a large sample field of view of ˜18 cm² is achieved by using an optical fiber bundle to map the fluorescence signal of 25 wells onto a small area (diameter ˜10 mm) in front of the cellphone camera (FIG. 4A). This fiber bundle, together with the fluorescence imaging system formed by the mobile phone lens and an external lens, create a total demagnification factor of >13 within a very compact design, where the overall height of the device is <10 cm.

In a single image, without any mechanical scanning this hand-held device can read an array of 5×5=25 wells of a conventional 96-well plate all in parallel. The optically transparent plate, quite conveniently, can be inserted into the reader device in either direction, which means 50 wells of the same plate can be measured in two successive measurements. At the bottom of each well of the optically transparent plate, three optical fibers (0.4 mm dia. each) are mounted (in a base plate), and at the other end of the fiber bundle, the optical fibers are randomly grouped and held in the header. A look-up map of fiber location versus the well position (i.e., a pre-defined arrangement of fibers and wells) was established before the actual experiments to map each particular fiber location in the image with the actual well of the optically transparent plate. This only needs to be performed once per device design. The optical fibers may, alternatively, be positioned in a regular arrangement in the header (i.e., following a predefined pattern).

FIG. 4A illustrates a representative output fiber image pattern captured on the mobile phone reader, where only seven (7) of the twenty-five (25) wells were randomly loaded with fluorescein solution (i.e., wells #s 1, 5, 13, 17, 19, 21, and 25). This unique design has significant advantages: (1) the fiber bundle helps one achieve a cost-effective, compact and light-weight fluorescence imaging design with a large demagnification factor so that a wide sample area of ˜18 cm² can be imaged without the need for any mechanical scanning or bulky optics (note that due to the random arrangement of the optical fibers in the header, there is no need to form matching rows and columns of the fibers in the header which introduces manufacturing complexity and expense); and (2) each one of the three fibers per well experience different amounts of spatial aberrations, noise as well as losses and their averaging minimize well-to-well variations of this design. Although in these experiments, blue excited, green emission fluorescent dyes were used that cover a wide range of intercalators and DNA probes, the multimode optical fibers are compatible with a wide range of wavelengths and by appropriately selecting the excitation/emission filters and LEDs, the same platform can easily be adapted for digital readout and quantification of various fluorescent and colorimetric assays.

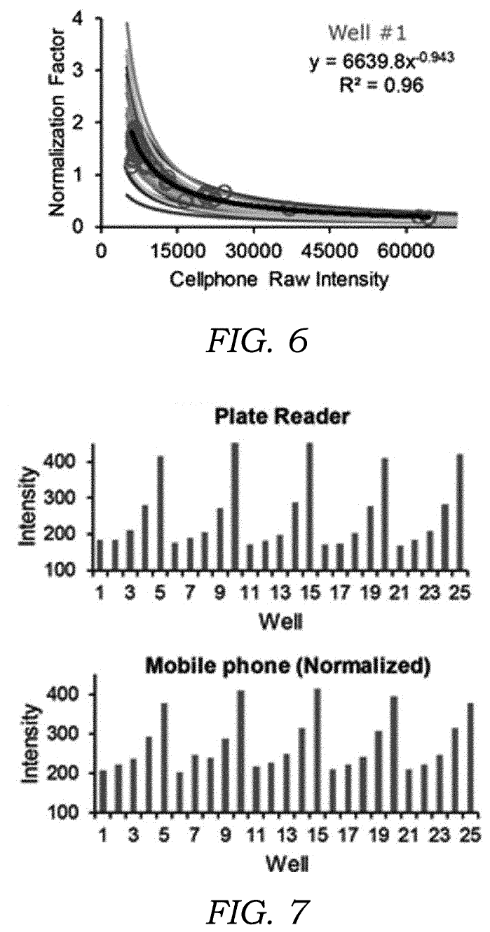

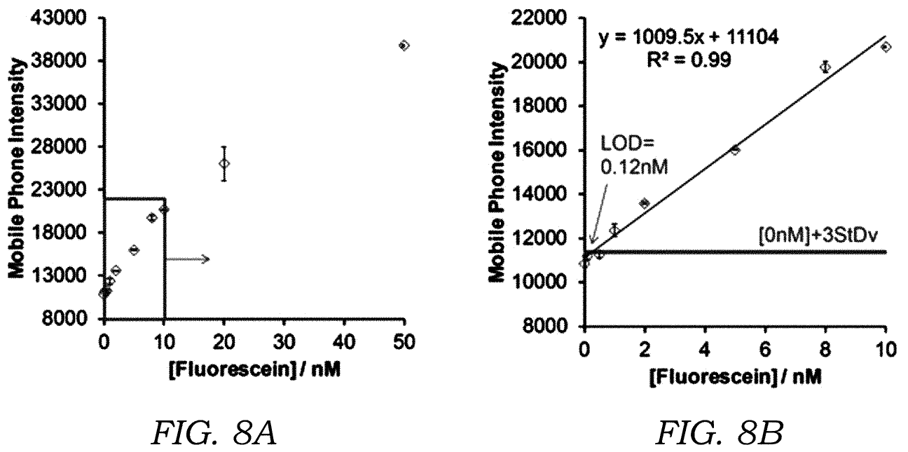

The performance of each well of the mobile reader device was calibrated against the readings of a conventional benchtop plate reader, which reads each well in a serial manner, i.e., using a mechanical scanning system. As detailed previously, following image format conversion, segmentation, and intensity averaging from three (3) fibers, a normalization factor was obtained by dividing the mean cellphone intensity reading by the corresponding benchtop fluorescence reading. For example, the circles in FIG. 6 represent a set of normalization factors for the 1^{st} well position only, which is superimposed on its fitting curve (dark), together with the rest of the calibration curves for the remaining 24 wells in the background. FIG. 7 shows the comparison between the conventional benchtop plate reader measurements (top—Biotek™) and the mobile phone fluorescent plate reader (bottom). After proper calibration and normalization, a series of diluted fluorescein solutions were blindly tested for each well position of the mobile reader device. Based on linear regression between the mobile phone intensity readings and the dye concentration in the range of 0-10 nM, the limit of detection (LOD) was determined by a threshold of three times the standard deviation of the blank control samples added to their mean (see FIGS. 8A and 8B). The results illustrate that all the twenty-five (25) well positions showed a LOD of <1 nM fluorescein with a mean LOD of 0.18 nM as seen in Table 1 below.

TABLE 1

| Well | LODs/nM |
|---|---|
| 1 | 0.12 |
| 2 | 0.13 |
| 3 | 0.60 |
| 4 | 0.14 |
| 5 | 0.09 |
| 6 | 0.10 |
| 7 | 0.50 |
| 8 | 0.33 |
| 9 | 0.19 |
| 10 | 0.10 |
| 11 | 0.10 |
| 12 | 0.20 |
| 13 | 0.08 |
| 14 | 0.33 |
| 15 | 0.11 |
| 16 | 0.10 |
| 17 | 0.03 |
| 18 | 0.21 |
| 19 | 0.10 |
| 20 | 0.06 |
| 21 | 0.37 |
| 22 | 0.09 |
| 23 | 0.18 |
| 24 | 0.07 |
| 25 | 0.10 |
| Average | 0.18 |
| LOD | |

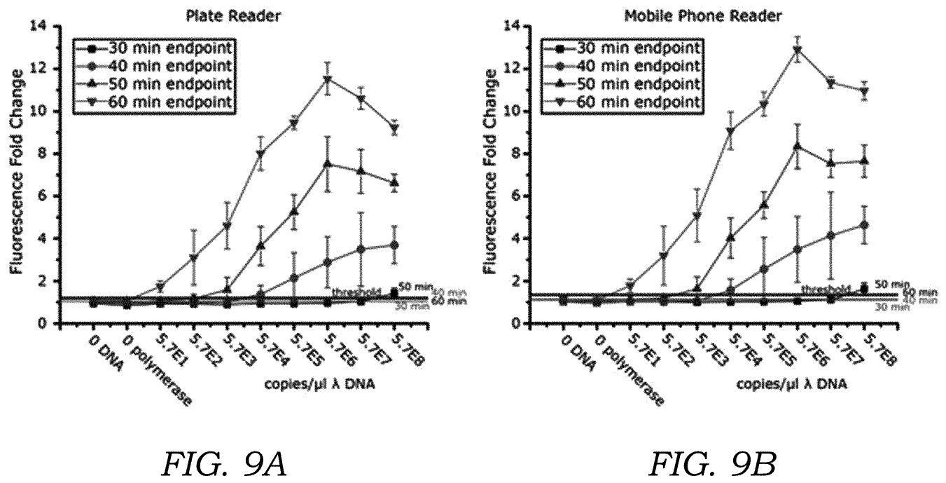

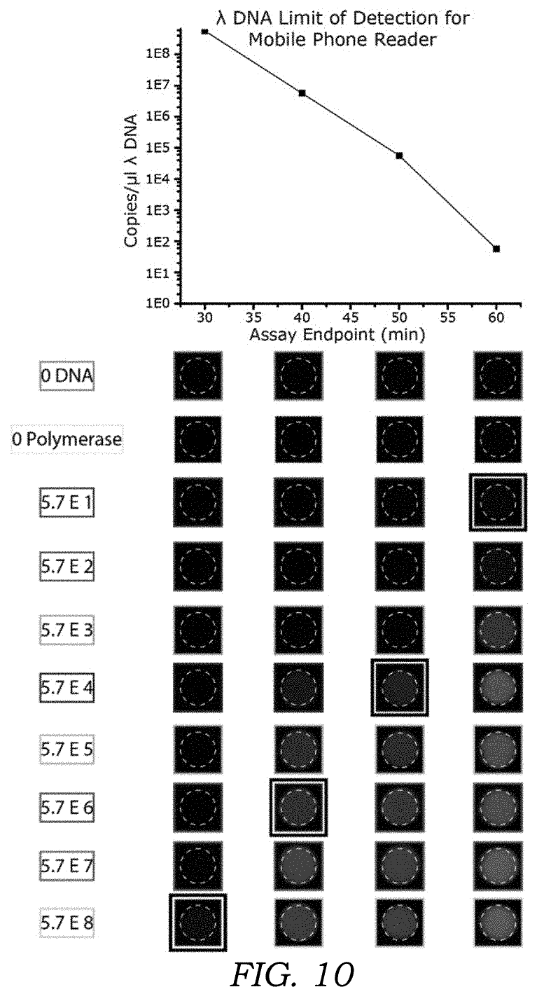

After establishing the LOD of the mobile fluorescent plate reader, next it was applied to analyze signals from enhanced loop-mediated isothermal amplification (LAMP) reactions that included hydroxynaphthol blue (HNB) an intercalating dye. The LAMP process amplifies DNA (λ DNA) and the presence can be detected through the use of HNB fluorescent dye. Comparing the fluorescent fold changes for the mobile phone-based design and the benchtop plate reader and (FIGS. 9A and 9B, respectively), one can clearly see that the trends match and the concentrations of λ DNA that can be distinguished above background are the same for both the benchtop plate reader and the POC mobile phone-based reader. For both systems the fluorescence fold change measured above background is significantly elevated with the HNB additive compared to a LAMP reaction alone, which results in a lower limit of detection. The amount of DNA amplification that occurs during the assay is dependent on the length of time the assay runs. As such, the longer the assay is run, the lower initial λ DNA concentration is needed in order to generate a signal above baseline. This leads to a lower LOD as time increases, as shown in FIG. 10. After 60 minutes, the assay can detect as few as 57 copies/μL λ DNA which approaches the limit of detection of approximately 11 copies/pt DNA reported by Khairnar et al. which was performed in a laboratory setting. See Khairnar et al., Multiplex real-time quantitative PCR, microscopy and rapid diagnostic immuno-chromatographic tests for the detection of Plasmodium spp: performance, limit of detection analysis and quality assurance, Malar J., 8:284 (2009).

Therefore, the system can detect a similar amount of DNA using techniques suitable for POC or low-resource settings. In fact, the ability to amplify DNA from ˜50 copies/μL level is sufficient to detect a wide range of disease states, microbial populations, or rare gene mutations. For example, meningococcal bacterial DNA load in patients ranges from 22-1.6×10⁵ copies/μL, with the median being 1.6×10³ copies/μL.

While embodiments of the present invention have been shown and described, various modifications may be made without departing from the scope of the present invention. For example, in an alternative embodiment, the portable electronic device may be include a stand-along imager device that is designed specifically to be used as part of the multi-well plate reader is not a separate electronic device that is used by consumers (e.g., like a mobile phone, tablet PC or the like). The invention, therefore, should not be limited except to the following claims and their equivalents.

1. A multi-well plate reader for use with a portable electronic device having a camera therein comprising:
an opto-mechanical attachment configured to attach/detach to the portable electronic device comprising:
an array of excitation illumination sources;
an excitation filter;
a slot disposed in the opto-mechanical attachment and dimensioned to receive an optically transparent plate containing an array of wells therein;
an emission filter;
a plurality of optical fibers disposed in the opto-mechanical attachment and configured to transmit fluorescent light emitted from the array of wells and through the emission filter, wherein each optical fiber of the plurality of optical fibers terminates at a first end in a base plate contained in the opto-mechanical attachment and forming an input array of optical fibers, wherein one or more optical fibers are positioned within a cross-sectional area defined by each of the wells of the optically transparent plate, wherein the plurality of optical fibers terminate at a second end in a header to form an output array of optical fibers therein, wherein the output array of optical fibers in the header has a cross-sectional area that is smaller than an area of the array of wells in the optically transparent plate and wherein the output array of optical fibers are mounted in the header;
a lens disposed in the opto-mechanical attachment and interposed in an optical path formed between the array of optical fibers in the header and the camera of the portable electronic device.

2. The multi-well plate reader of claim 1, wherein the one or more optical fibers positioned within a cross-sectional area defined by each of the wells comprises one optical fiber for each well.

3. The multi-well plate reader of claim 1, wherein the one or more optical fibers positioned within a cross-sectional area defined by each of the wells comprises at least two optical fibers for each well.

4. The multi-well plate reader of claim 1, wherein the portable electronic device comprises one of a mobile phone, a tablet computer, webcam, a digital camera, or a stand-alone imager.

5. The multi-well plate reader of claim 4, wherein the portable electronic device comprises a mobile phone or tablet computer, the mobile phone or tablet computer containing an application thereon configured to process images taken with the camera of the mobile phone or tablet computer and display the total fluorescent intensity for each well of the array as a function of time or at a certain time point.

6. The multi-well plate reader of claim 5, wherein the application contains a fiber map that maps each of the optical fibers in the header to a particular well of the array.

7. The multi-well plate reader of claim 1, wherein the opto-mechanical attachment comprises one of a memory, bar code, QR code containing a fiber map that maps each of the optical fibers in the header to a particular well of the array.

8. The multi-well plate reader of claim 1, wherein the array of illumination sources comprise a plurality of light emitting diodes (LEDs) or a plurality of laser diodes.

9. The multi-well plate reader of claim 1, further comprising a power source disposed in the opto-mechanical attachment for powering the array of illumination sources.

10. The multi-well plate reader of claim 1, wherein the plurality of optical fibers comprise glass or polymer multimode optical fibers.

11. The multi-well plate reader of claim 1, wherein the output array of optical fibers in the header are secured in a random pattern within an aperture formed in the header.

12. The multi-well plate reader of claim 1, wherein the output array of optical fibers in the header are secured in a non-random pattern within an aperture formed in the header.

13. (canceled)

14. A method of using the multi-well plate reader of claim 3 comprising:
securing the opto-mechanical attachment to the portable electronic device;
loading samples into separate wells in the optically transparent plate;
inserting the optically transparent plate into the slot of the opto-mechanical attachment;
illuminating the wells in the optically transparent plate using the array of excitation illumination sources;
acquiring a pattern image of the fluorescent light emitted by the output array of optical fibers;
transmitting the pattern image to a remote computing device or a local computing device;
processing the transmitted pattern image in the remote or local computing device to map each location in the pattern to a particular well using a fiber map;
averaging, for each well, the measured fluorescent intensity values from the plurality of optical fibers;
normalizing the averaged fluorescent intensity values with fluorescent intensity values from a separate reader device; and
returning a quantitative value or qualitative result corresponding to the normalized fluorescent intensity for the separate wells to the portable electronic device for display thereon.

15. The method of claim 14, wherein normalizing comprises retrieving calibration data from the remote computing device or a local computing device.

16. The method of claim 14, wherein the quantitative value comprises a concentration value for a target molecule or target species.

17. The method of claim 14, wherein the quantitative value comprises a nucleic acid copy number.

18. The method of claim 14, wherein processing the transmitted pattern image further comprises extracting a single color channel from the one or more images acquired by the multi-well plate reader.

19. A method of using the multi-well plate reader of claim 4 comprising:
securing the opto-mechanical attachment to the portable electronic device;
loading samples into separate wells in the optically transparent plate;
inserting the optically transparent plate into the slot of the opto-mechanical attachment;
illuminating the wells in the optically transparent plate using the array of excitation illumination sources;
acquiring a pattern image of the fluorescent light emitted by the output array of optical fibers;
processing the pattern image in the portable electronic device to map each location in the pattern to a particular well using a fiber map;
averaging, for each well, the measured fluorescent intensity values from the plurality of optical fibers;
normalizing the averaged fluorescent intensity values with fluorescent intensity values from a separate reader device; and
displaying on the portable electronic device a quantitative value or qualitative result corresponding to the normalized fluorescent intensity for the separate wells.

20. The method of claim 19, wherein the quantitative value comprises a concentration value for a target molecule or target species.

21. The method of claim 19, wherein the quantitative value comprises a nucleic acid copy number.
